(19) United States
(12) Patent Application Publication
(10) Pub. No.: US 2013/0288598 A1
(43) Pub. Date: Oct. 31, 2013

(54) Radio Frequency Communication Device

(71) Applicant: Frederick N. Parkin, Centurion (ZA)

(72) Inventor: Frederick N. Parkin, Centurion (ZA)

(21) Appl. No.: 13/879,096

(22) PCT Filed: Oct. 14, 2011
(86) PCT No.: PCT/IB2011/002425

§ 371 Date: Jul. 9, 2013

(30) Foreign Application Priority Data
Oct. 15, 2010 (ZA) 2010/07384
Feb. 28, 2011 (ZA) 2011/01542

(51) Int. Cl. G06F 1/16

(52) U.S. Cl. CPC G06F 1/1626
USPC 455/41.1

(57) ABSTRACT

An RFC (including NFC) adapter device (10) is provided that can be associated with a mobile communications device (14), typically a mobile phone, to extend the capabilities of the communications device. The adapter device (10) has a body (11) housing a radio frequency antenna, a processor for processing signals and a communications connector (13) that is connectable to a port of the mobile communications device (14) so that the adapter device may send and receive electronic signals to and from the communications device in a first electronic format and convert the electronic signals between the first electronic format and a radio frequency format in which it is capable of being transmitted or received by the adapter device cooperating with a second RFC device or a co-operant RF reader device in close proximity to it. The adapter device preferably connects with an audio input/output port (15) of the mobile communications device. The adapter device preferably has a unique identifier (12) associated with it and stored in an electronic memory module housed within the body.

### CROSS-REFERENCE TO RELATED APPLICATION

The present application is the United States national phase under 35 USC §371 of International Patent Application No. PCT/IB2011/02425, filed Oct. 14, 2011, which application claims priority of South Africa Application No. 2011/01542, filed Feb. 28, 2011, and South Africa Application No. 2010/07384 filed Oct. 15, 2010. The entire text of each of the priority applications is incorporated herein by reference.

### FIELD OF THE INVENTION

This invention relates to a radio frequency communication device including near field communication (NFC) technology as may be conveniently and securely used for payment, transaction, data, voice and video communication and/or identification purposes. The capability of radio frequency and NFC technology is referred to in this document collectively as “RFC”.

Also, in this specification with term token includes a voucher, and an identification string that may be configured for a dedicated purpose, as will be quite apparent to those skilled in the art.

### BACKGROUND TO THE INVENTION

Radio frequency identification (RFID) tags are increasingly being used in a wide range of applications. These include identification solutions such as building access cards (also referred to as proximity cards), product tracking labels, animal tracking tags and library book tags, as well as payment solutions such as public transit tickets, toll road billing and, more recently, in various electronic wallet applications.

RFID tags are powered by resonant energy transfer and have a range of approximately 0-8 centimeters in most instances. The resonant energy transfer takes place via an LC circuit. An IC, capacitor, and coil are connected in parallel. The tag reader presents a field that excites the coil and charges the capacitor, which in turn energizes and powers the IC. The IC then transmits the tag number via the coil to the tag reader.

A drawback of existing RFID tags is that separate tags must generally be used for each specific application. For example, a person may have an RFID tag for accessing company premises, another RFID tag used on public transit, yet another RFID tag for purchasing meals at a cafeteria and so on. Carrying multiple RFID cards and/or tags is inconvenient; increases the risk that one or more of them may get lost; and makes replacing them burdensome.

The integration of multiple tags into a single RFID tag has been hampered by a lack of common standards, and efforts to bring out such consolidated cards have been largely unsuccessful.

Near field communication, or NFC as it is commonly referred to, is a set of short-range wireless technologies, typically requiring a distance of up to 20 centimeters between two NFC enabled devices to enable them to communicate with each other wirelessly. NFC typically operates at 13.56 MHz and at rates ranging from 106 kbit/s to 848 kbit/s. NFC communication always involves an initiator device and a target device. NFC operates in one of two modes, namely passive communication mode in which one of the devices is passive in that it does not have its own power supply, and active communication mode in which both devices are active in that they typically have their own power supplies.

In passive communication mode the initiator device generally actively generates an RF field that can power a passive target device. This enables NFC targets to take on a very simple form such as tags, stickers, key fobs, and cards that do not require batteries. RFID tags, as explained above, are examples of NFC devices operating in passive communication mode. NFC peer-to-peer (“P2P”) is an example of the active communication mode and occurs when both initiator and target devices are powered. Two powered devices can also operate in passive communication mode if the one device temporarily switches off its power supply.

NFC technology is currently aimed at being used mainly in mobile phones and for three specific uses namely; card emulation in which the NFC device in the phone behaves like an existing contactless card (proximity card); reader mode in which the NFC device in the phone is active and is capable of reading a passive RFID tag; and P2P mode in which two active NFC devices in two separate phones are communicating together and exchanging information.

A problem foreseen with the incorporation of NFC technology in mobile phones is, however, that only new generation phones and “smart phones” are likely to be equipped with this technology. Users with older technology and low cost phones will therefore be unable to have access to the technology.

### SUMMARY OF THE INVENTION

In accordance with the invention there is provided an RFC adapter device comprising a body housing an antenna for receiving and/or transmitting radio frequency signals, a processor for processing signals and a communications connector, characterized in that the communications connector is connectable to a port of a mobile communications device, the adapter device being operable to send and receive electronic signals in a first electronic format to and from the mobile communications device when connected thereto, and the processor being operable to convert signals between the first electronic format and a radio frequency format in which it is capable of being transmitted or received by the adapter device to or from at least a second RFC device or a co-operant RF reader device in close proximity to it.

The term “close proximity” in this specification is intended to mean cooperating radio-frequency proximity that fulfils the security requirements of the situation in which the adapter device is used. Typically such proximity would mean within about 10 meters and in the case of NFC, it means that the co-operating distance between such RFC (NFC) devices is, as indicated above, a maximum of about 80 mm and more typically a maximum of about 20 mm to 40 mm with present day technology. It is envisaged, however, that technology will change, and these distances may likewise change. Also the distance between the adapter device and a co-operating RFC or RF device would depend on the power available to drive the adapter device which may be either of the active or passive type.

Further features of the invention provide for the port to be an analog or digital input/output port such as an audio input/output port of the mobile communications device; for the mobile communications device to be a mobile phone; for the connector to be a TRS (tip, ring, sleeve) or USB connector or similar connector compatible with a communications port on a wireless communications device; for the first electronic format to be an audio or digital electronic format; and for the device to be powered by the communications device by means of at least one powered surface contact associated with the port.

Still further features of the invention provide for the adapter device to have a unique identifier associated with it, the identifier being stored in an electronic memory module housed within the body; for the adapter device to be operable to transmit the unique identifier to other RFC devices in close proximity to it and to receive identifiers uniquely associated with such other RFC devices; and for the adapter device to be configured to automatically exchange identifiers with other RFC devices in close proximity to it.

Yet further features of the invention allow for signals received from the electronic communications device to define a desired communications standard and an associated token to be presented by the adapter device; and for the adapter device to be operable to generate the token in the desired standard and present the token to be read by an associated RF reader or other RFC device in close proximity to it.

Still further features of the invention provide for the token presented by the device to be usable once-off or for a defined period, after which a new token must be generated.

Yet further features of the invention provide for the signals received from the mobile communications device to incorporate a token obtained from a third party server in response to a request made by a user of the adapter device by way of a software application on the mobile communications device; and for the third party server to be a web server accessible by the user by means of the software application or an independent Internet browser application operating on the mobile communications device.

It will be understood that, as a general rule, the adapter device provided by this invention will be fitted to a port of a mobile communications device, especially a mobile telephone such as a cellular telephone, to enable the communications device to perform activities beyond its normal capability and that are analogous to activities that can be performed by modern-day more upmarket communications devices that have a built in RFC communications circuit, commonly an NFC circuit.

An RFC adapter device conversion unit comprising a body having an antenna for receiving and/or transmitting radio frequency signals, a processor for processing signals and communications connection terminals, characterized in that the communications connector terminals are connectable to an interface otherwise utilized by the mobile communications device for sending and receiving audio signals, the adapter device being operable to send and receive electronic signals in a first electronic format to and from the mobile communications device when connected thereto, and the processor being operable to convert signals between the first electronic format and a radio frequency format in which it is capable of being transmitted or received by the adapter device to or from at least a second RFC device or a co-operant RF reader device in close proximity to it.

Further features of the invention provide for the software application to include functionality for selecting, such as by way of menus, between one or more of various modes of payment at a plurality of different merchants; identification of the user at a plurality of locations; transfer of a token between RFC devices; the transfer of a token or voucher from an RFC device associated with a first user to an RFC device associated with a second user; the transfer of a physically removed quantity, such as money, from an account associated with a user of a first RFC device to an account associated with a user of a second RFC device; and the conducting of a transaction between a first user and a second user.

According to one aspect of the invention, it is provided for the adapter device to function as an RF identification tag; for the RF reader to be a premises access control reader; and for the token to be a code identifying a particular individual for use in access control, such as building entry.

According to a second aspect of the invention, it is provided for the adapter device to function as an RF payment tag for facilitating payments between a user and a merchant; for the RF reader to be a merchant payment reader device; for the token to be a code identifying an amount to transfer from an account associated with the user to an account associated with the merchant; and for the token to have been pre-acquired by the user from an online server by means of the software application.

According to a third aspect of the invention, it is provided for the adapter device to function as an RF payment tag for facilitating payments directly between two users; and for the token to be a code identifying the amount to be transferred from the one user to the other, the payment being initiated by the users bringing their RFC devices into close proximity with one another.

According to a fourth aspect of the invention, it is provided for the adapter device to function as a means of conducting a transaction between users of first and second RFC devices; for the transaction to be specified by first and second users by means of the software applications operating on their respective mobile communications devices; for the first and second RFC devices to be configured to exchange and store encrypted versions of their respective identifiers when brought into close proximity with each other; and for the respective mobile communications devices to which the first and second adapter devices are connected to be configured to transmit the encrypted identifiers, preferably in combination with their own unique identifiers, to a remote server in order to conclude the transaction.

The invention also provides a user authentication and/or transacting system comprising an RFC device including a body housing an antenna for receiving and/or transmitting radio frequency signals, a processor for processing signals and a communications connector configured to be connectable to a port of a mobile communications device associated with a user; and a software application operable on the mobile communications device; the system being characterized in that the software application is configured to communicate with the RFC device by means of the port and connector and in that the port and connector are configured to enable the mobile communications device to provide power to the RFC device.

Further features of the invention provide for the communications connector to be an audio connector and for the port to be an audio port of a mobile communications device.

Still further features of the invention provide for the software application to be configured to transmit data to the RFC adapter device by means of an output selected from an audio output port, an analog output port and/or a digital output port of the mobile communications device and to receive data from the RFC adapter device by means of an input port selected from an audio or microphone input port, an analog input port and/or a digital input port of the mobile communications device.

Yet further features of the invention provide for the software application to be further configured to receive a token from a third party server over the Internet in response to a request made by the user by means of the software application on the mobile communications device and to transmit the token to the RFC adapter device via the port and connector; for the RFC device to in turn be configured to receive the token from the software application and to generate the token in a desired standard and present the token to be read by an associated RFC reader.

A further feature of the invention provides for the RFC device to be operable in both active and passive formats.

Still further features of the invention provide for the token to be any one of the group comprising credit to an account associated with the user, a key providing access to the user to an access restricted area or application, and credit to be transferred from an account associated with a first user to that of another.

In accordance with a further aspect of this invention there is provided a mobile communications device having a near field communications (NFC) module incorporated therein, characterized in that the NFC module is incorporated so as to communicate with a processor of the mobile communications device by means of an interface otherwise utilized by the mobile communications device for sending and receiving audio signals.

Further features of the invention provide for the RFC module to be mounted on a printed circuit board of the mobile communications device in line with an audio interface of the mobile communications device; for the RFC module to be an integrated circuit chip, for the chip to include an antenna for receiving and/or transmitting radio frequency signals, and a microprocessor operable to send and receive electronic signals in a first electronic format to and from the mobile communications device processor, and convert signals between the first electronic format and a radio frequency format in which it is capable of being transmitted or received by the RFC module to or from at least a second RFC enabled device in close proximity to it.

A still further feature of the invention provides for the RFC module to be integrated onto a printed circuit board of an existing mobile communications device.

The invention still further provides a method of converting a mobile communications device to include near field communications (RFC) functionality, the method including integrating an RFC module in a printed circuit board of the mobile communications device in a manner that enables the RFC device to communicate with a processor of the communications device over an existing audio interface of the communications device.

### BRIEF DESCRIPTION OF THE DRAWINGS

In the drawings:—

FIG. 1 is an illustration of one embodiment of adapter device according to the invention;

FIG. 2 is similar to FIG. 1 showing a connector of the adapter device in a stowed position;

FIG. 3 is circuit diagram of the adapter device illustrated in FIGS. 1 and 2;

FIG. 4 illustrates the combination of a mobile telephone and the embodiment of adapter device according to the invention illustrated in FIGS. 1 and 2;

FIG. 5 illustrates one form of flow of data typical of a transaction carried out using an adapter device according to the invention; and,

FIG. 6 illustrates the system in which the adapter device according to the invention and a mobile telephone operate.

### DETAILED DESCRIPTION WITH REFERENCE TO THE DRAWINGS

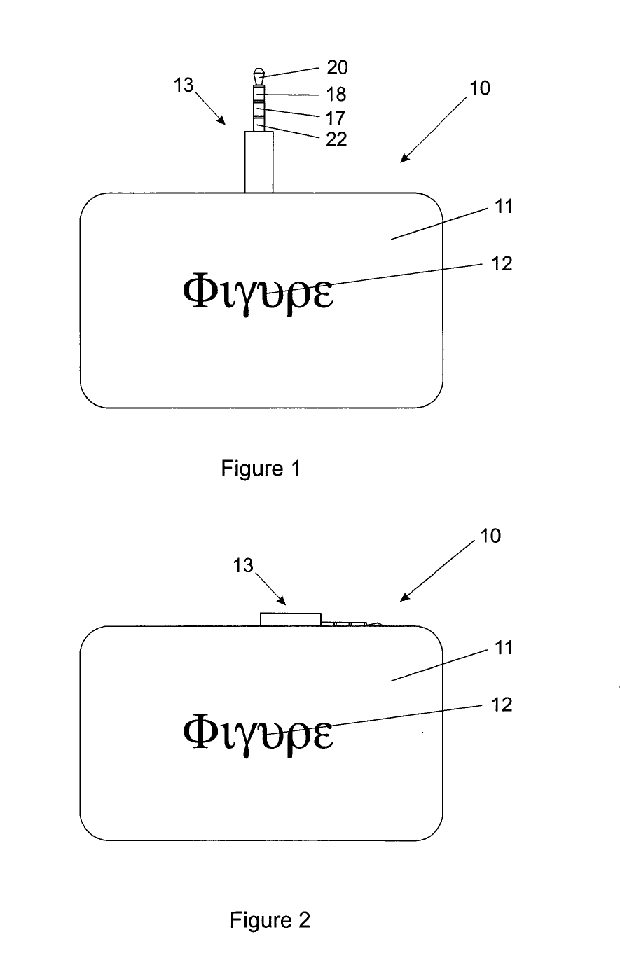

In the embodiment of the invention shown in FIGS. 1 to 4, an RFC adapter device (10) includes a body which in this case includes a thin plastic case (11) enclosing electronic circuitry. The body may have identifying indicia (12) printed thereon, and may be of any suitable size or shape, it being understood that the illustrated embodiment is purely for purposes of explanation and is suitable for production by presently available technologies.

The body includes a communications connector (13) (typically a TRS connector) by means of which the adapter device can be connected to a mobile telephone (14). In this embodiment of the invention the communications connector is an audio connector which is connectable to the audio/microphone input/output port (15) of the mobile telephone. The connector includes four contacts, namely a data read contact (17), a data write contact (18), a power contact (20) and a ground contact (22). The contacts (17, 18, 20 and 22) correspond to the microphone in, stereo 2, stereo 1 and ground contacts of a conventional stereo audio connector, respectively. The connector (13) is pivotable between an extended condition shown in FIG. 1 in which the connector extends at a right angle to the nearest edge of the plastic case, and into a stowed position shown in FIG. 2 in which the connector (16) lies generally parallel with a nearest edge of the plastic case. It is to be mentioned that the reason for using the plastic case is primarily to house the antenna and it is the intention, once technology allows, to do away with the plastic case portion and to house the entire circuit in the body of the connector.

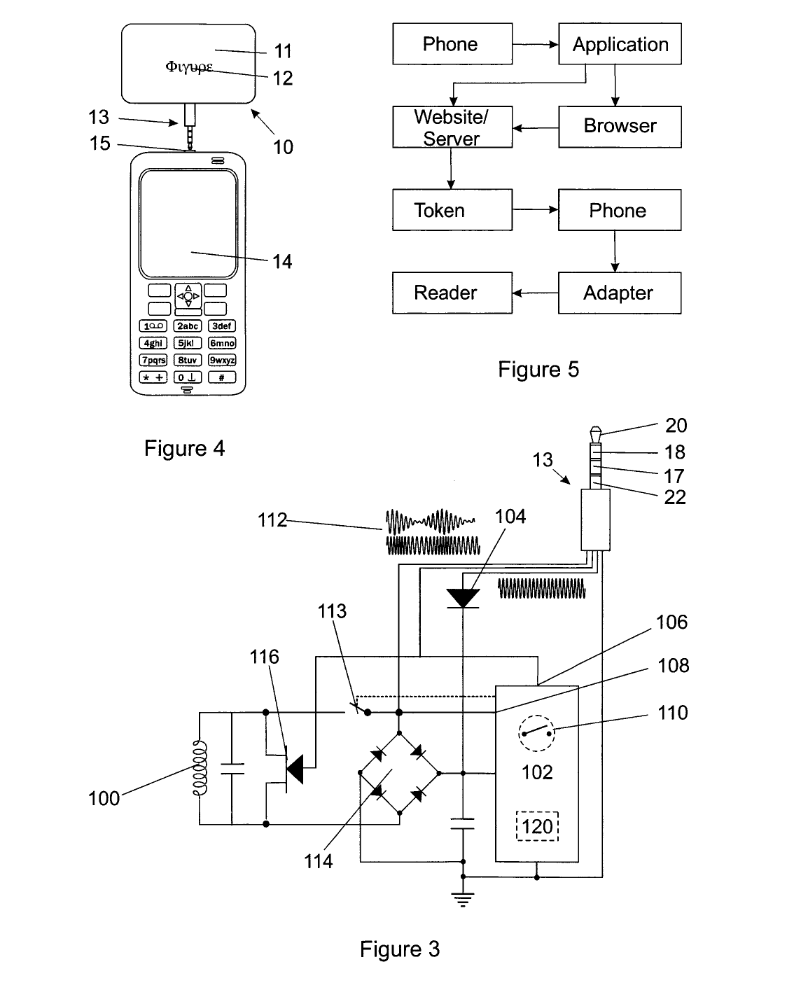

FIG. 3 shows a circuit diagram of the electronic circuitry housed within the body (12). The circuit includes an antenna (100) for receiving and/or transmitting radio frequency signals, and a processor (102), typically in the form of an integrated circuit, for modulating and/or demodulating and processing the signals. The circuit also includes the communications connector (13) also shown in FIGS. 1 and 2. The power signal (20) is passed through a rectifier (104) to provide DC power to the processor, and the processor (102) has a data out port (106) and a data in port (108). The circuit is switchable between a read mode and a write mode by means of a switch (110) which is controlled by the microprocessor. A second switch (113) opens or closes the connection of the data in port (108) with the antenna.

In write mode, the switch (110) is switched to “write” and the second switch (113) is opened. An audio signal (112) is received from the mobile telephone through the data write contact (18), and this signal is input into the processor after being rectified by a full bridge rectifier (114). This audio signal defines a desired communications standard and an associated token to be presented by the adapter device. The processor (102) uses the audio signal to calculate a token and convert it to a radio frequency signal, which is then presented by means of outputting it to the antenna (100) through the output port (106) by means of a transistor (116).

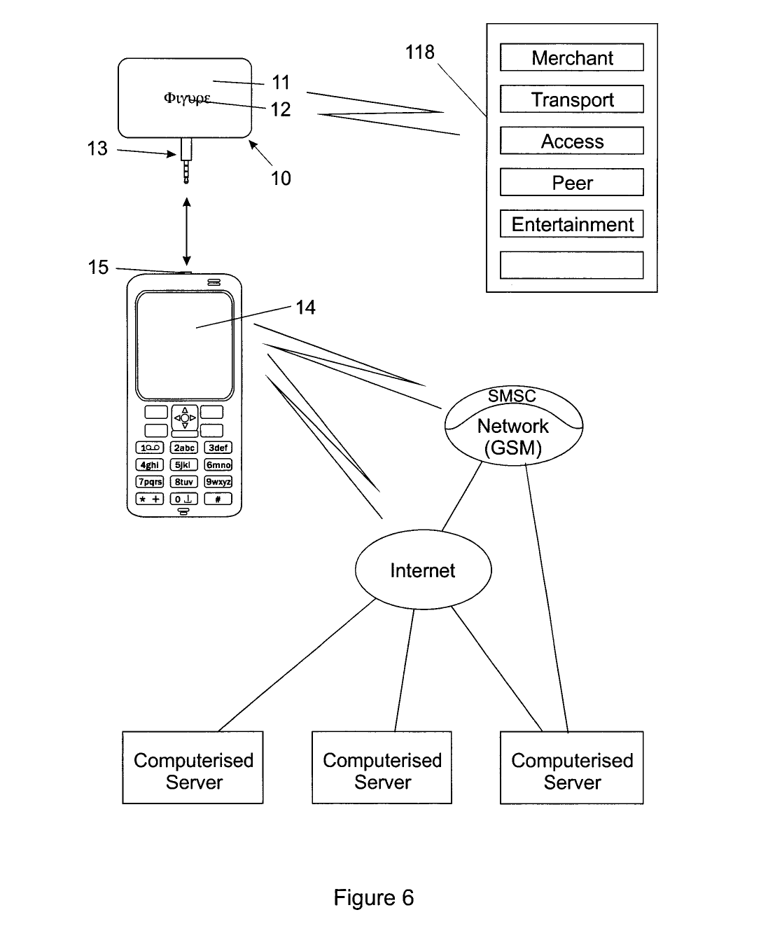

The presented token can be read by an RF reader (118) (see FIG. 6) which is brought into close proximity with the antenna, for example when the RFC device is tapped against a door security RF reader.

In read mode, the switch is switched to “read” and switch (113) is closed. The output port (106) of the processor generates an audio signal (112) that is input to the mobile telephone through the data read contact (17). This audio signal (112) is determined by the processor based on rectified input radio frequency signal received by the antenna and input into the processor though the data in port (108) where it is converted into an audio or digital signal, as the case may be. In read mode, the RFC device can detect and communicate with another RFC device, as will be further described below.

The RFC device has a unique identifier associated with it which is stored in a secure location in a memory module (120) incorporated in the processor integrated circuit. It should be appreciated that the identifier could be allocated to and stored on the device at the time of manufacturing, in which case the RFC device will have the same identifier associated with it for its complete lifetime. Alternatively, the identifier could be issued to it by a remote entity, communicated to the mobile phone of the user to which it is associated and then transferred and stored on the RFC device when connected to the mobile phone. In this way the identifier may also be associated with the user and a new identifier may be issued to the device each time it changes ownership. The unique identifier may also be uniquely associated with a particular mobile phone, in which case the identifier may be changed each time the device is used with a different mobile phone handset.

Whichever way they are allocated, it is intended that all RFC devices will have unique identifiers associated with them. When two RFC devices attempt to communicate when brought into close proximity to each other, the devices firstly exchange identifiers, preferably in an encrypted format. Once the exchange has taken place, each device will be in possession of an encrypted copy of the other device's identifier and a transaction which was setup by the users on a software application on their respective mobile phones can be concluded. The transaction may also be concluded by the mobile phones of the users sending copies of the encrypted identifiers, in combination with their own identifiers, to an independent third party server for verification of the transaction.

The RFC adapter device can be used in a variety of applications selectable by means of the software application available on the mobile phone. For example, the RFC device can be used as an identification tag to gain access to premises. In this example, the user plugs the tag into the audio port of the mobile telephone and initiates the software application. The user then dials a predefined number or selects a particular option in the software application, which causes the mobile phone to connect via the Internet to a third party server on which the user's mobile telephone number or other identifier has previously been registered.

If the third party server recognizes the user's mobile phone and/or the device's identifiers, it returns a data token to the mobile phone together with instructions as to the format in which the token must be presented by the adapter device. The software application then converts this token and format instructions into an audio signal that is input to the adapter device through the audio connector, with the switch in write mode. The processor of the adapter device uses the audio signal to determine the correct format in which the token should be presented, converts the received signal into a radio frequency signal and the token is then presented by means of outputting it to the antenna (100) through the output port (106).

The device may then be unplugged from the mobile phone and all the user has to do is hold the adapter device close to an RF reader, for example a premises access control reader, so that the RF reader can read the presented token. For security purposes it is envisaged that the token presented by the adapter device will be usable once-off or for a defined period, after which a new token must be generated. It should also be appreciated that each adapter device will have a unique identifier whereby a user may also be authenticated or authentication may be verified.

The RFC device can also be used for facilitating payments between a user and a merchant, for example when a user pays for public transit at a train station. In this example the adapter device will generally be used in an active condition, in other words, while connected to the mobile phone and its power supply. In one instance the user initiates the software application on his or her mobile phone and selects a merchant payment option, in this example payment for a train ticket. The application then connects with a third party server, for example a banking server, where the user maintains a banking account. After proper authentication, the user selects the suitable payment option and the amount to be paid to the merchant and such amount is then reserved for payment to the merchant at a future time. When the user arrives at the train access point, he or she connects the device to his or her mobile phone and presents it to an RFC access device of the train service. A device identifier exchange then takes places after which the user's device has an encrypted copy of the identifier of the access device and vice versa. Both the user's device and access device then transmits the encrypted identifiers of the other device, together with their own identifiers, to a transaction server, which could be the same banking server. This transmission may take place over the Internet. The transaction server then checks that the user has sufficient funds or credit, as the case may be, deducts the amount for the payment from the user's account and passes the funds or credit to an account of the merchant (train operator). The user then receives confirmation of the payment on his or her mobile phone and the transaction is concluded, after which the user is granted access to the train terminal.

In an alternative arrangement the user may have a virtual “purse” or “wallet” associated with the merchant and which is represented by means of the adapter device. Funds may be transferred or “loaded” into the virtual purse and are then typically deducted from it by presenting the adapter device to an RF reader at the point of purchase. When the payment is requested from the third party server by the user, the third party server generates an encrypted token that includes information as to the payment amount and returns the token to the mobile phone. The software application then converts this token into an audio signal that is input to the adapter device through the audio connector, with the switch (110) in write mode. The processor in the adapter device converts the audio signal into a radio frequency signal and presents the token by storing it on memory for a certain time and outputting it to the antenna. When the antenna is brought into close proximity with an RF reader, the presented token is read and processed by the computer systems of the merchant's RF reader. The RF reader then sends the token to the third party server, which then authenticates the transaction and credits the merchant account. The user may receive a message, such as an SMS, confirming that the amount has been transferred, and the merchant also receives a confirmation of the received funds.

In the last example described above, the RFC device may function in either an active or passive format. In the passive format, the tag may be removed from the mobile phone once the desired token has been loaded on it, and may then be used in the same way as a conventional passive RF tag or proximity card.

A further example of how the RFC adapter device may be used in an active format is when the device is used to facilitate payments directly between two individuals by means of their mobile phones, provided both mobile phones have the RFC devices of the invention. In this example, user A wishes to transfer funds to user B. To do so, the user A sets his phone, by means of the software application, to PAY mode and enters the amount to be paid to user B. User B in turn sets his phone to RECEIVE PAYMENT mode by means of the software application. With the RFC devices attached to both phones, user A then brings his device in close proximity to user B's device. As before, the devices exchange identifiers and user A's device then has an encrypted copy of the identifier of user B's device and vice versa. Each device then sends the encrypted identifier of the other device, together with its own identifier to a banking server by way of the associated mobile phone. In addition, user A's device also sends details of the payment amount to the server. The server in turn notifies user A of the amount to be paid to user B by means of an appropriate message to the mobile phone after which user A is required to either accept or reject the transaction by means of an appropriate return message. On receipt of an acceptance of the transaction the server checks that user A has sufficient funds or credit, deducts the amount from his account and in turn credits user B's account. Both user A and B then receive an appropriate message on their respective mobile phones confirming that the payment was effected.

A further example of how the RFC adapter device in accordance with the invention may be used in an active format is where a first user, user B, buys a cellular airtime voucher (represented by means of a token) from an online merchant and then transfers it to a second user, user A. In order to buy the token, user B inserts the RFC adapter device into the audio port of his or her mobile phone and initiates the software application on the mobile phone. User B then selects the airtime application, enters the required amount to be purchased and confirms the purchase. The software application then connects to a merchant server which requests the user to enter his or her cellphone number. The merchant server then presents the payment request to a banking server with which the user has an account, together with the cellphone number and identifier of the user's RFC adapter device. The banking server in turn transmits a request to the user's mobile phone requesting him or her to accept or deny the transaction for the specified amount. On acceptance of the transaction by the user, the banking server processes the payment and sends confirmation of the payment to the user and merchant. The merchant in turn issues an electronic pin or token representing the airtime and sends it to the mobile phone from where it is uploaded to the user's attached RFC adapter device.

User B then selects a “transfer token” function on the software application and user A selects a “receive token” function on the software application on his or her mobile phone. By bringing the RFC devices attached to their respective mobile phones into close proximity, the token is transferred from user B's device to user A's device and will be communicated to user A's mobile phone from where it may be activated.

It should be immediately apparent that the example described is not limited to airtime, and may be used to purchase any token, voucher or redeemable commodity and transfer it between RFC devices. The invention therefore provides an easy and effective way of purchasing and transferring tokens and vouchers while alleviating the need to transcribe long voucher or pin numbers.

It should be appreciated that when the RFC device operates in an active format it draws its power from the mobile phone audio port. Active devices can typically operate over longer distances and generally need less expensive readers in order to communicate. An active device can itself be a reader for another active device, which allows for transfer of information to and from an active device solution.

When used in the passive format the RFC device relies on a signal from an external RF reader or other RFC device to provoke signal transmission. In this case the device could be used even if not connected to the mobile phone. The mobile phone could then be used to, for example, define the mode of the device or to top up the balance on the device.

It will be appreciated that the RFC device of the invention facilitates convenient and secure identification and payment applications across multiple platforms using a communications device that did not formally have that capability. A user is not required to carry separate devices or RFID cards, but the correct token can be presented in the correct format when required by the user, by making the appropriate selection on the mobile phone software application and obtaining proper authorization from a third party server.

The invention therefore provides an RFC adapter device that uses the audio/microphone connector of a mobile phone as a means to communicate with the device and supply power to it. The RFC device is thereby capable of communicating with other RFC devices in close proximity to it. This considerably broadens the application of currently available tags.

The system in accordance with the invention which includes both the RFC adapter device and the software application on the mobile phone, allows for remote access of services, and is used to allow the device to communicate over the Internet to load a virtual purse associated with the adapter device, to provide access to applications, to allow tokens to be loaded onto the adapter device and the like.

The above descriptions are by way of example only and it will be appreciated that numerous modifications may be made to the embodiments described without departing from the scope of the invention. In particular, it is foreseen that an RFC module may also be provided that could be built into an existing mobile phone. The module could, for example, be fitted to the existing printed circuit board (PCB) of the mobile phone so as to communicate with the phone's processor over an existing audio interface of the phone. In this example the RFC module could be in the form of a silicon integrated circuit microchip which incorporates all the functionality of the standalone device explained above. What is important is that the module will communicate with the mobile phone over an existing channel otherwise used by the phone for sending and receiving audio signals. While it is foreseen that the module may be populated onto the phone's printed circuit board it is of course equally possible for the RFC module to be incorporated in the audio interface of the phone at the time of manufacture.

The invention therefore makes it possible for existing mobile phones to make use of near field communication technology, thereby significantly reducing the cost of rolling out this technology on a large scale.

It is also foreseen that the RFC device explained with reference to the accompanying drawings may be easily adapted to incorporate a large number of additional features. For example, the device may be fitted with an infra red (IR) transmitter which could be controlled by an appropriate software application installed on the mobile phone to which it is attached, to operate as a remote control for a large number of devices. The software application may, for example, be configured to instruct the device to change the signal being emitted by the IR transmitter in accordance with the requirements of a number of IR operated devices that are programmed on the application. The device will then be instructed by the software applications by means of the audio interface of the mobile phone, how to operate the IR transceiver. It is foreseen that a large number of devices including multimedia devices, motor vehicles, and IR access controls, to name but a few, may be controlled in this way.

The RFC device may also be operated as part of a proximity alarm system for, for example, the mobile phone to which it is connected. This can be achieved by providing a secondary transmitter which emits a continuous signal that the RFC device is capable of recognizing. The RFC device could be programmed to allow the mobile phone to function normally for as long as it is able to detect the presence of the transmitter. As soon as the phone, with the RFC device attached to it, is moved out of range of the transmitter the RFC device may be programmed to instruct the phone to lock itself, close down proprietary applications or perform any number of alternative functions. In this way the phone may be rendered useless if taken outside of the range of the transmitter.

It should be appreciated that if the transmitter is carried on the person of the owner of the phone, that the phone will only be useful for as long as it is in close proximity to the user. The RFC device could likewise be programmed to instruct the phone to unlock itself as soon as it comes within range of the transmitter. This could, for example, be as soon as the owner comes in close proximity to the phone.

From the above it should be apparent that the RFC device and its ability to communicate with the mobile phone by means of existing analog, audio and digital interfaces makes it possible to substantially expand the useful functionality of existing mobile phone.

1. An RFC adapter device comprising a body housing an antenna for receiving and/or transmitting radio frequency signals, a processor for processing signals and a communications connector, wherein
the communications connector is connectable to a port of a mobile communications device,
the adapter device being operable to send and receive electronic signals in a first electronic format to and from the mobile communications device when connected thereto, and
the processor being operable to convert signals between the first electronic format and a radio frequency format in which it is capable of being transmitted or received by the adapter device to or from at least a second RFC device or a co-operant RF reader device in close proximity to it.

2. An RFC adapter device as claimed in claim 1 wherein which the port is an audio input/output port of the mobile communications device.

3. An RFC adapter device as claimed in either one of claim 1 wherein the mobile communications device is a mobile phone.

4. An RFC adapter device as claimed in claim 1 wherein the connector is a TRS (tip, ring, sleeve) or USB connector or similar.

5. An RFC adapter device as claimed in claim 1 which is configured to be powered by the communications device by means of at least one powered surface contact associated with the port.

6. An RFC adapter device as claimed in claim 1 which has a unique identifier associated with it stored in an electronic memory module housed within the body and wherein the adapter device is operable to transmit the unique identifier to other RFC devices in close proximity to it and to receive identifiers uniquely associated with such other RFC devices.

7. An RFC adapter device as claimed in claim 6 which is configured to automatically exchange identifiers with other RFC devices in close proximity to it.

8. An RFC adapter device as claimed in claim 1 wherein the processor is operable to convert signals representing a token between the first electronic format and a radio frequency format.

9. An RFC adapter device conversion unit comprising a body having an antenna for receiving and/or transmitting radio frequency signals, a processor for processing signals and communications connection terminals, wherein
the communications connector terminals are connectable to an interface otherwise utilised by the mobile communications device for sending and receiving audio signals,
the adapter device being operable to send and receive electronic signals in a first electronic format to and from the mobile communications device when connected thereto, and
the processor being operable to convert signals between the first electronic format and a radio frequency format in which it is capable of being transmitted or received by the adapter device to or from at least a second RFC device or a co-operant RF reader device in close proximity to it.

10. An RFC adapter device conversion unit as claimed in claim 9 wherein the body includes an integrated circuit chip.

11. An RFC adapter device as claimed in claim 9 which is operable in both active and passive formats.

12. In combination, an adapter device as claimed in claim 1 and a mobile telephone selected to co-operate with the adapter device and having an application thereon whereby the mobile telephone can provide a signal in a first electronic format that the adapter device can convert to a radio frequency format.

13. A combination as claimed in claim 12 in which the software application includes functionality for selecting from one or more of the group including various modes of payment at a plurality of different merchants; identification of the user at one or more locations; transfer of a token between RFC devices; the transfer of a token from an RFC device associated with a first user to an RFC device associated with a second user; the transfer of a physically removed quantity from an account associated with a user of a first RFC device to an account associated with a user of a second RFC device; and the conducting of a transaction between a first user and a second user.

14. A system including the combination claimed in claim 12 wherein the software application or an independent browser application on the mobile communications device enables communication with a third-party server from which a token is available for transfer to the mobile communications device in electronic format and thence to the adapter device for conversion into radio frequency format.

15. A mobile communications device having a near field communications (NFC) module incorporated therein, characterized in that the NFC module is incorporated so as to communicate with a processor of the mobile communications device by means of an interface otherwise utilized by the mobile communications device for sending and receiving audio signals.
